(19) United States
(12) Patent Application Publication
(10) Pub. No.: US 2018/0008097 A1
(43) Pub. Date: Jan. 11, 2018

(54) PUCK ASSEMBLY FOR A BLENDER CONTAINER

(71) Applicant: Vita-Mix Management Corporation, Olmsted Township, OH (US)

(72) Inventor: Fred Mehlman, Brunswick, OH (US)

(21) Appl. No.: 15/642,466

(22) Filed: Jul. 6, 2017

Related U.S. Application Data
(60) Provisional application No. 62/358,609, filed on Jul. 6, 2016.

(51) Int. Cl. A47J 43/046; B01F 15/00; A47J 43/07

(52) U.S. Cl. CPC A47J 43/046; A47J 43/0716; B01F 15/00538

(57) ABSTRACT

A blender container and puck assembly is generally described. The puck assembly may include a retainer nut that affix a blade assembly to the blender container. The puck assembly is not directly fastened to the container. The puck assembly may include an identification tag that interacts with a transponder.

### CROSS-REFERENCE TO RELATED APPLICATIONS

This application claims priority to U.S. Provisional Patent Application No. 62/358,609 entitled “PUCK ASSEMBLY FOR A BLENDER CONTAINER,” filed on Jul. 6, 2016, which is incorporated herein by reference in its entirety.

### BACKGROUND

Blenders and blending systems are often used to blend and process foodstuffs. Frozen, frosty, or icy drinks have become increasingly popular. Such drinks include the traditional shakes, and the more recently popular smoothies. Shakes, or milk shakes, are typically formed of ice cream and/or milk, and flavored as desired, with or without additives, such as candies, chocolates, peanut butter, fruits, etc. Milkshakes typically are available at most fast-food restaurants, such as burger chains, and may be made by special machines, or hand-made using mixers.

Smoothies tend to be healthier, and may be formed of ice, frozen yogurt, and/or sorbet. Smoothies may include additives such as fruits, fruit juice, vegetables, vitamins, supplements, etc. Smoothies typically are available from specialty chains or juice bars, and may be made with commercial or restaurant-grade blender. Such drinks also may be made at home, using a personal blender.

Blenders traditionally include a blade assembly attached with a container. The blade assembly of these blenders often requires complex geometries or specific geometries to assist in mixing the contents in the container appropriately. The blade assemblies are driven by a motor to rotate blades of the assembly.

Various methods are known to reduce the sound created by a blender. One such method includes providing an enclosure around the container of the blender to contain the noise. These enclosures can also increase the size of the blenders. Therefore, a need exists for an improved means for blending contents. Further, there is a need for reducing noise and vibrations during blending of foodstuff.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

A blender apparatus may include a container and a puck assembly. The puck assembly may include a retainer nut. The retainer nut may attach a blade assembly to the container. The retainer nut may be indirectly coupled with the container. The blade assembly may be isolated from direct contact with the container by the puck assembly. The puck assembly may include an identification tag that communicates with a transponder.

A blender apparatus may include a container and a blade assembly operatively positioned in the container. The blender apparatus may also include a puck assembly comprising a retainer nut, wherein the retainer nut is not directly attached to the container.

A blender apparatus may include a blender base comprising a motor and a container operatively engageable with the blender base. The blender apparatus may also include a blade assembly isolated from the container, the blade assembly in operatively coupled with the motor.

A puck assembly for a blender apparatus may include a body operatively coupled to a blade assembly and an identification tag disposed within the puck assembly.

The following description and the drawings disclose various illustrative aspects. Some improvements and novel aspects may be expressly identified, while others may be apparent from the description and drawings.

### DESCRIPTION OF THE DRAWINGS

The accompanying drawings illustrate various systems, apparatuses, devices and methods, in which like reference characters refer to like parts throughout.

FIG. 1 illustrates a container for a blender.

FIG. 2 illustrates a cross-sectional view of a puck assembly and a portion of a container.

FIG. 3 illustrates an exploded view of a blender base.

FIG. 4 illustrates an exploded, cross-sectional view of a puck assembly and a portion of a container.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” or terms of similar import do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that the various embodiments described herein may include other components and/or functionality, including, without limitation, those components and functionality of known blending systems. It is further noted that while various embodiments refer to a blender or a blending system, various other systems may be utilized in view of embodiments described herein. For example, embodiments may be utilized in food processor systems, mixing systems, hand-held blending systems, various other food preparation systems, and the like. As such, references to a blender, blending system, and the like, are understood to include food processor systems, and other mixing systems. Such systems generally include a blender base that may include a motor, a controller, a display, a memory and a processor. Further, such systems may include a blending container and a blade assembly. The blade assembly, the blending container, and the blender base may removably or irremovably attach. The blending container may be powered in any appropriate manner, such as disclosed in U.S. patent application Ser. No. 14/213,557, entitled Powered Blending Container, which is hereby incorporated by reference. Foodstuff may be added to the blending container. Furthermore, while blending of “ingredients,” “contents” or “foodstuffs” is described by various embodiments, it is noted that non-food stuff may be mixed or blended, such as paints, epoxies, construction material (e.g., mortar, cement, etc.), and the like. Further, the blending systems may include any household blender and/or any type of commercial blending system, including those with covers that may encapsulate or partially encapsulate the blender. Further, commercial blending systems may include an overall blending system, such as a modular blending system that may include the blender along with other components, such as a cleaner, foodstuff storage device (including a refrigerator), an ice maker and/or dispenser, a foodstuff dispenser (a liquid or powder flavoring dispenser) or any other combination of such.

Moreover, blending of foodstuff or ingredients may result in a blended product. Such blended products may include drinks, frozen drinks, smoothies, shakes, soups, purees, sorbets, butter (nut), dips or the like. It is noted that various other blended products may result from blending ingredients. Accordingly, terms such as “blended product” or “drink” may be used interchangeably unless context suggests otherwise or warrants a particular distinction among such terms. Moreover, such terms are not intended to limit possible blended products and should be viewed as examples of possible blended products.

In some traditional blending devices, rotation of blades in a container and operation of a motor may produce a large amount of noise that may be undesirable for a user. For instance, a user may operate the motor to drive blades. This may cause vibrations that may be transferred from the motor to other components of a blender base, such as a shell, container or the like. The vibration may result in noise or be at least one source of the noise from the blending assembly during operation. This noise may increase at high speeds or blending of particular ingredients. This noise may be undesirable for consumer applications and in business applications. In an example, a commercial kitchen may employ one or more blenders to produce frozen drinks. These commercial kitchens may desire to reduce noise such that customers may place orders and are comfortable at the commercial kitchen.

In embodiments, a blender assembly may include a blender base, container, a puck assembly, and a blade assembly. The blade assembly may comprise blades disposed within the container. The puck assembly may couple the blade assembly to the container and may serve as a mount for the blade assembly. The container may be attached to a blender base that comprises a motor. Operation of the motor may drive the blade assembly. Driving the blade assembly may produce or be a source of noise or vibrations occurring during operation of the blending assembly.

In embodiments, the puck assembly may be removably or fixedly attached to the container and may mount the blade assembly to the container. The puck assembly may include a retainer nut that is not screwed, bolted, fastened, or otherwise attached to the container. The lack of fasteners or other attachment device may reduce vibrations with respect to blending apparatuses that include such fasteners. In another aspect, the retainer nut may comprise an elastomeric material that may be compressed against the container. The compression and/or elastomeric material may reduce noise and vibration—it may act as a dampening device. These components may act alone or in combination as a dampening device, which may result in reduced vibrations and/or noise.

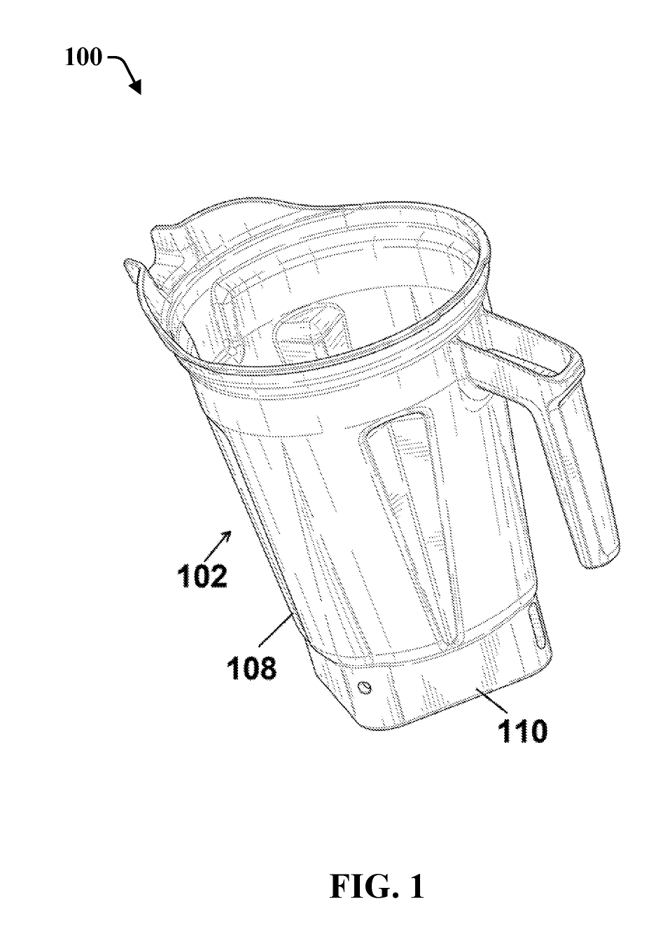

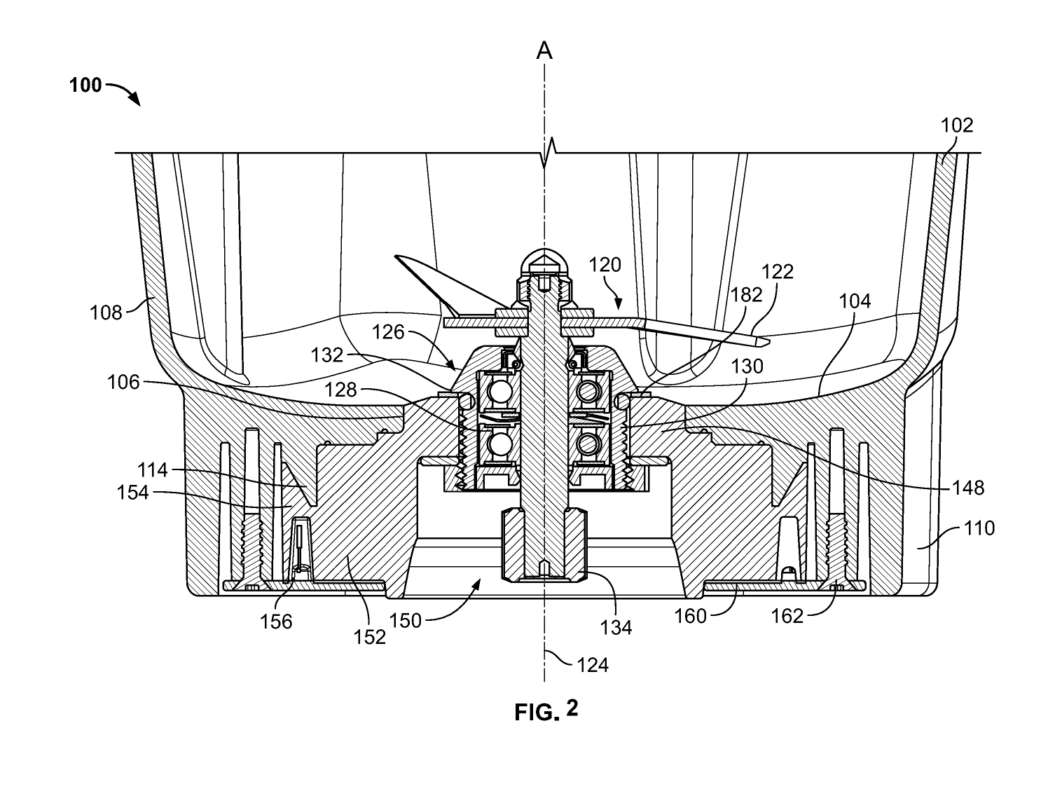

Turning now to FIGS. 1 and 2, there is a blender assembly 100 in accordance with various disclosed aspects. The blender assembly 100 may include a container 102 that is operatively connected with a blender base (not shown), such as in a known manner. The container 102 may be operatively assembled with a blade assembly 120 and a puck assembly 150 (which may include a retainer nut 152). In an aspect, the blade assembly 120 may be isolated from direct contact and/or direct attachment with the container 102. For instance, the puck assembly 150 may provide a point of contact with the container 102. The blade assembly 120 may be mounted on the puck assembly 150 such that the blade assembly 120 does not contact the container 102.

According to embodiments, container 102 may comprise various shapes, sizes, and/or dimensions. For instance, container 102 may comprise a pitcher-shape, cup-shape, a bowl-shape, or the like. In an example, container 102 may comprise generally rectangular-shaped side walls 108 (which may transition to cylindrical in shape) and a bottom wall 104. A user may place foodstuff within the container 102 for blending. By way of a non-limiting example, the container 102 may be similar in structure to that disclosed in U.S. Pat. Nos. 8,529,120, 8,814,011, 8,753,004, 7,063,456, and 7,267,478 all of which are hereby incorporated by reference.

Blade assembly 120 may be disposed proximal the bottom wall 104. For example, the blade assembly 120 may be positioned within an aperture 106 of the bottom wall 104. The blade assembly 120 may comprise one or more food processing implements, such as one or more blades 122 coupled to a drive shaft 124. The drive shaft 124 may pass through a bearing housing 126 that may house one or more bearings 128. The bearing housing 126 may comprise a perimeter comprising a splined portion 130 (or any other engagement configuration). It is noted that the blades 122, drive shaft 124, bearing housing 126, and the like may comprise various materials, such as metal, plastic, or the like. The drive shaft 124 may comprise a splined coupler 134 at an end opposed to the blades 122. The splined coupler 134 may couple with a motor (e.g., such as via a drive shaft of a motor) to allow the motor to rotate the blade assembly 120.

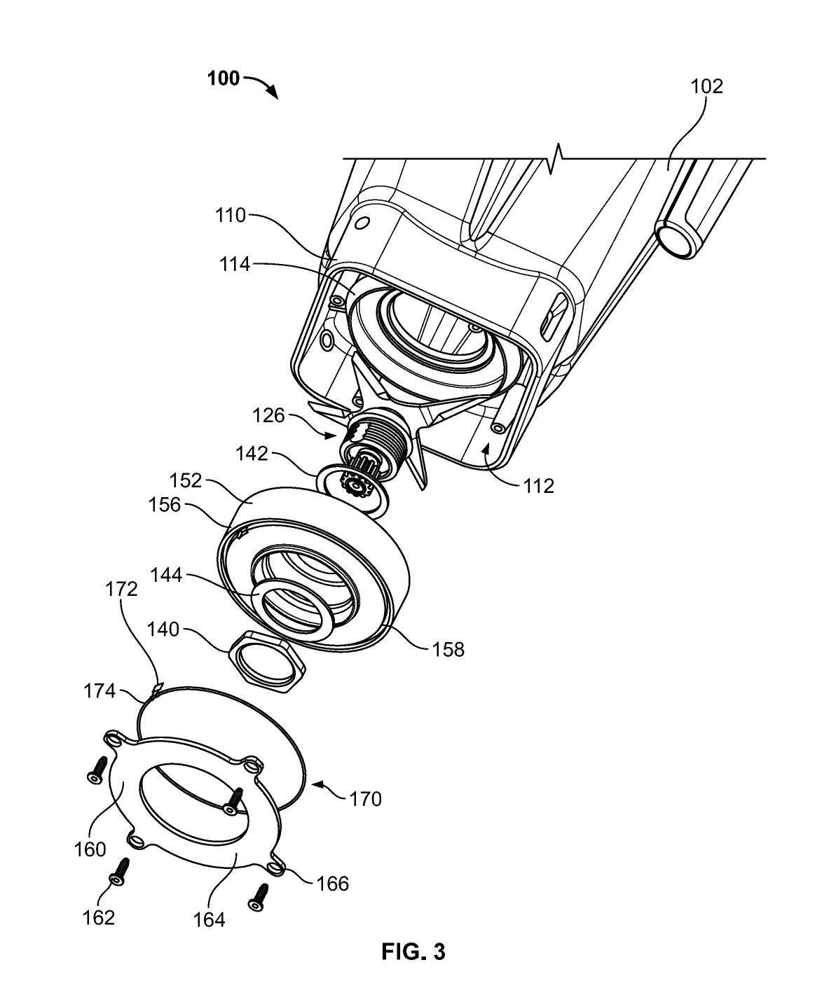

The puck assembly 150 may comprise retainer nut 152, which may be disposed within a cavity 112 of an apron 110 of the container 102, as shown in FIG. 3. In an aspect, the retainer nut 152 may extend through aperture 106. The bearing housing 126 may be disposed within an aperture 180 of the retainer nut 152, such that the splined portion 130 of the bearing housing 126 protrudes from a bottom 184 of the aperture 180. A lip 132 (as shown in FIG. 2) of the bearing housing 126 may contact a top 182 of the aperture 180. It is noted that a gasket 142 may be disposed between the lip 132 and the top 182 of the aperture 180. At least one embodiment may not comprise gasket 142 or may comprise other members disposed between lip 132 and retainer nut 152. In some embodiments, the gasket 142 may provide a seal to generally prevent food and/or liquid material from exiting the container 102 (or entering into the blender base). Further, the gasket 142 may act as a further dampening device to generally reduce vibrations from occurring during operation and/or reduce notice that may occur during operation.

It is further noted that the bearing housing 126 does not contact the container 102, which may comprise a hard or generally stiff material that does not generally exhibit elastomeric properties. The bearing housing 126, rather, contacts the retainer nut 152. The retainer nut 152 may comprise an elastomeric, thermosetting elastomeric, or other material that may absorb vibrations, i.e., it may comprise a dampening material. For example, the retainer nut 152 may comprise a plastic material that may absorb vibrations while providing a somewhat rigid mount for the blade assembly 120. In at least one embodiment, the splined portion 130 may be prevented from contacting the container 102. For instance, the splined portion 130 may be generally friction-fitted within the aperture 180. In some embodiments, the retainer nut 152 may comprise one or components that may be attached together, such as through use of fasteners, welding, adhering or the like. In other embodiments, the retainer nut 152 may be integrally formed such as a monolithic member.

Isolation of the blade assembly 120 from the container 102 may prevent and/or reduce the blade assembly 120 from transferring vibrations to the container 102. For instance, an elastomeric retainer nut 152 may generally absorb some or all vibrations while allowing the blade assembly 120 to have a more flexible mount. This may reduce vibration transfer from the blade assembly 120 to the container 102 when compared to blender systems where a blade assembly is in contact with a container. For instance, rotation of the blade assembly 120 may cause the shaft 124 to move in a slightly elliptical motion or otherwise wobble about an axis A of the drive shaft 124—some form of precession of the blade assembly 120 may occur. A slight precession may result in additional vibration and/or noise during operation. This is particularly true with the precession of the blade assembly 120 when positioned in the container 102. The container 102 may act as an amplifier, which may increase the noise resulting from the precession of the blade assembly 120. The shape and size of the container 102 may contribute or increase the amplifying effect. Reducing or eliminating the precession may reduce the noise that otherwise may occur. Further, the retainer nut 152 may reduce the noise that otherwise occurs during precession of the blade assembly 120. This may reduce the amplifying effect of the container 102 to further reduce the noise present during operation. The elastomeric properties of the retainer nut 152 may allow for some wobble or precession while reducing vibrations in comparison with a non-elastomeric (or generally non-elastomeric) material, such as materials typically used for container 102, which may reduce the noise that may occur during operation.

While retainer nut 152 may be described as comprising an elastomeric material, it is noted that the retainer nut 152 may comprise other materials, such as metal or the like. In another aspect, the retainer nut 152 may comprise a core that is coated, overmolded, or otherwise coupled with an elastomeric material. For instance, the retainer nut 152 may comprise a metal core overmolded with a plastic material. The metal may provide weight and rigidity, while the elastomeric material may absorb or dampen vibrations.

In another aspect, while the blade assembly 120 is described as isolated from contact with the container 102, it is noted that one or more portions of the blade assembly 120 may come into contact with the container 102. As an example, a portion of the lip 132 may contact the body 104, but it may not be directly attached thereto. This may form a seal between lip 132 and the body 104 while the bearing housing 126 and other portions of the blade assembly 120 do not contact the container 102. In another example, the gasket 142 may be disposed between the lip 132 and at least a portion of the bottom 104. The gasket 142 may provide a seal that generally prevents food particles and liquid from exiting the container 102 during operation or otherwise. The gasket 142 may further provide dampening between the container 102 and the blade assembly 120.

As described herein, container 102 may include the apron 110. The apron 110 generally extends in an opposite direction as side walls 108 relative bottom wall 104. The apron 110 includes a cavity 112. Retainer nut 152 may be at least partially disposed within the cavity 112. The cavity 112 may be sized and shaped to receive the retainer nut 152. For instance, the cavity 112 may comprise a first engaging member such as a protrusion 114 that mates with a second engaging member such as groove 154 of the retainer nut 152. In an example, the protrusion 114 may comprise a generally circular ridge, and the groove 154 may comprise a generally circular groove that mirrors and operatively nests within the generally circular ridge. In an aspect, the groove 154 and the protrusion 114 may assist in aligning the retainer nut 152 with the container 102, which may help reduce precession and/or reduce noise associated with precession that may otherwise occur in prior art versions. The present disclosure further contemplates the opposite, i.e., the cavity 112 includes the second engaging member (e.g., the groove 154) and the retainer nut 152 includes the first engaging member (e.g., the protrusion 114). The present disclosure is not limited to the protrusion 114 and groove 154 shown, any mating features may be utilized without departing from the present teachings.

It is noted that the retainer nut 152 may be inserted with the cavity 112 and may be held in place without any fasteners (e.g., screws, bolts, rivets, etc.) being passed through or directly contacting the retainer nut 152. That is, the retainer nut 152 does not screw, bolt, or fasten directly to the blade assembly 120 or the container 102. In an aspect, a retainer plate 160 may compress or place force on the retainer nut 152 to maintain the position of the retainer nut 152. The retainer plate 160 may be fastened to the container 102 via one or more fasteners 162. It is noted that the retainer plate 160 may apply force to the retainer nut 152 such that the retainer nut 152 forms a seal with bottom wall 104 and/or lip 132, e.g., it may compress the retainer nut 152; especially those portions that comprise an elastomeric material. The retainer plate 160 may comprise a metal or other rigid material suitable for applying pressure to the retainer nut 152. It is further noted that the retainer plate 160 may be circular, an n-sided polygon (where n is a number), or other shape. Moreover, retainer plate 160 may comprise one or more flanges 166 extending from a body 164 that may receive a fastener 162.

As the fasteners 162 do not directly connect or contact the retainer nut 152, vibrations between the fasteners 162 and retainer nut 152 may be reduced. Retainer nut 152 may be forced outward towards the apron 110. In an aspect, groove 154 and the protrusion 114 may generally maintain the alignment of the retainer nut 152 while it is under pressure. In another aspect, the retainer nut 152 may retain flexibility to allow for slight wobbles in rotations of the blade assembly 120 or precession thereof. This may reduce noise occurring during operation of the blender assembly. Specifically, the retainer nut 152 may provide dampening between the drive shaft 124, splined coupler 134, and corresponding or mating components on the motor base, including, without limitation the motor spline and coupling device. This dampening effect may reduce noise that may otherwise occur during operation of the blender assembly. This may further reduce the amplifying effect of the container 102 during operation.

The drive shaft 124 may be positioned along a generally longitudinal axis A. During operation, the drive shaft 124 may precess with respect to the axis A, which may increase noise. The present retainer nut 152 may provide a dampening effect upon occurrence of the precession, which may reduce the noise that occurs during operation of the blender assembly. The retainer nut 152 may further reduce precession that may otherwise occur, which may reduce noise during operation.

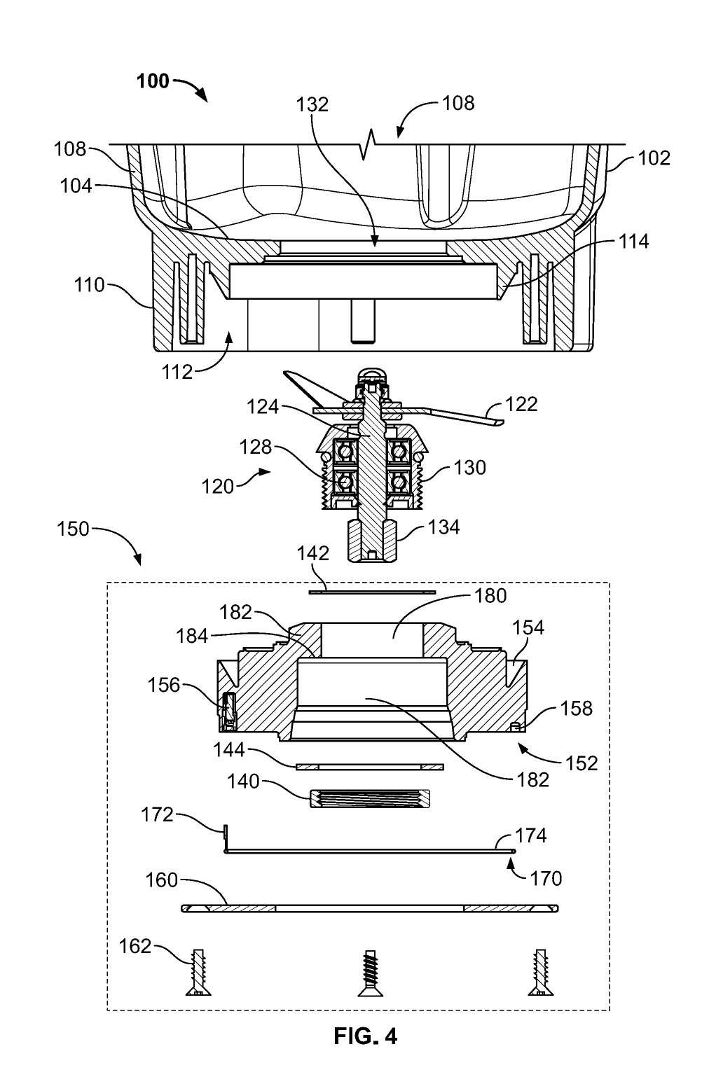

Turning to FIGS. 3-4, with reference to FIG. 2, there are exploded views of the blender assembly 100. As can be seen in the figures, an upper portion 148 of the retainer nut 152 may be disposed between the lip 132 and a fastener or nut 140. The nut 140 may comprise a threaded member operatively adapted to engage with the splined portion 130. The nut 140 may be tightened on the splined portion 130 to secure the blade assembly 126 with the retainer nut 152. While blade assembly 126 is shown below the container 102, it is noted that blade assembly 126 may be inserted within the container 102 and then coupled with the retainer nut 152.

In another aspect, puck assembly 150 may include one or more gaskets 142, 144. Gasket 142 may be operatively disposed between blade assembly 126 and retainer nut 152. For instance, the gasket 142 may be positioned between lip 132 and a top 182 of the aperture 180. In another aspect, gasket 144 may be positioned between a bottom 184 of the aperture 180 and the nut 140. The gaskets 142, 144 may comprise an elastomeric material that may be crushable or deformable. In another aspect, compression of the elastomeric material may form a seal and may provide dampening. While two gaskets are shown, embodiments may include other or different gaskets. For example, an embodiment may include i gaskets, where i is a number.

As described here as well as elsewhere, retainer nut 152 may be held in place or affixed to the container 102 via an indirect connection. For instance, retainer plate 160 may be positioned to apply pressure to a retainer nut 152 towards the container 102. A body 164 of the retainer plate 160 may comprise a frame-like shape that abuts the retainer nut 152. One or more flanges 166 may extend from the body 164 and may allow fasteners 162 to fasten the retainer plate 160 to the container 102. In an aspect, retainer plate 160 may apply pressure to deform gaskets 142 and/or 144, such that a seal is formed via gasket 142. The pressure may deform or compress an elastomeric material of retainer nut 152.

It is noted that retainer plate 160 may comprise any desired shape, such as a circular, polygonal, or irregular shape. In another aspect, retainer plate 160 may comprise a different number of flanges 166, no flanges 166, may different number of fasteners 162, and/or may not include fasteners. For example, retainer plate 160 may be overmolded to or with the container 102. Likewise, retainer plate 160 may be attached to the container 102 via various mechanisms, such as magnetic fasteners, mechanical fasteners, chemical connections, overmolding, or the like.

In at least one embodiment, puck assembly 150 may include an identification tag 170. The identification tag 170 may comprise a radio frequency identification (RFID) chip, transponder, or tag, a near-field communications (NFC) chip or tag, Bluetooth, and the like. Such identification tags may comprise printable RFID tags, NFC tags, tags including microchips, or the like. Identification tag 170 can contain stored information, such as in a memory. In another aspect, an identification tag 170 may be powered by electromagnetic induction from magnetic fields produced near a reader. For instance, an identification tag 170 may include an NFC chip that uses electromagnetic induction between two loop antennas located within the container 102's near field, effectively forming an air-core transformer. The antennas may comprise various materials, such as copper. While an air-core transformer is described, various other antenna formations may be utilized.

As described herein, the identification tag 170 may include an NFC chip 172 and an antenna 174. The antenna 174 may receive a signal from a component of a blender apparatus, such as a base (not shown), scale (not shown), or the like. The signal may power the NFC chip 172 and/or induce a response in the NFC chip 172. In other embodiments, the NFC chip 172 may be powered from an internal power source, such as a battery.

It is noted that NFC chip 172 may store information such as an identity of container 102, characteristics of container 102 (e.g., use time, cycles, models number, etc.). In an example, the NFC chip 172 may provide a signal to a base that may be utilized to identify that the container 102 is configured to interact with the base and may identify whether or not the container 102 is properly interlocked with the base. For example, if the container 102 is within a near field of the base, the NFC chip 172 may be within a field of a transceiver of the base. This may allow the NFC chip 172 to communicate with the base and may signify that the container 102 is interlocked with the base. If it is not within the field, the NFC chip 172 will not communicate with the base. When in the field, NFC chip 172 may provide a signal to the base so that the motor may be operated. When outside the field, the motor will be disabled. It is noted that NFC chip 172 and/or identification tag 170 may communicate with other components, such as a display on a container. Moreover, NFC chip 172 may comprise a processor and a memory storing processor executable instructions.

As depicted, retainer nut 152 may include a groove 158 that may be elliptical in shape and a tag chamber 156 that may receive NFC chip 172. In an aspect, the groove 158 may be sized and shaped to receive the antenna 174. Likewise, the tag chamber 156 may be sized and shaped to receive the NFC chip 172. It is noted that the identification tag 170 may be disposed in other portions of the blender apparatus 100. For instance, identification tag 170 may be disposed in or on apron 110.

NFC chip 172 and/or antenna 174 may be sealed (e.g., hermetically sealed) within the retainer nut 152 and/or a packaging. This may allow the identification tag 170 to be placed in a liquid, a dishwasher, or the like. It is further noted that the retainer nut 152 may be overmolded with the identification tag 170 in place, such that the identification tag 170 is disposed within the retainer nut 152. This may protect the identification tag 170 from an external environment.

It is noted that embodiments may include different or additional components than shown in the drawings. Moreover, aspects of this disclosure may be utilized with other apparatuses. While various components may be referred to as separate or distinct components, it is noted that such components may be monolithically formed. Likewise, components me be comprised of various subcomponents that may or may not be monolithically formed with each other.

It is further noted that various modifications are within the scope and spirit of this disclosure. For instance, a drive coupler may comprise different components, shapes, or the like. Moreover, drive sockets may or may not be splined, e.g., it may be any polygonal shape. As such, various other mechanisms may be utilized for attaching a blade assembly to a drive coupler. Moreover, while embodiments have been illustrated as comprising a clip, tabs, or the like, a drive coupler may be attached to a drive shaft by various other methods, such as threaded connections, screws, bolts, rivets, other fasteners, magnetic connections, welding, or the like.

Although the embodiments of this disclosure have been illustrated in the accompanying drawings and described in the foregoing detailed description, it is to be understood that the present disclosure is not to be limited to just the described embodiments, but that the embodiments described herein are capable of numerous rearrangements, modifications and substitutions without departing from the scope of the claims hereafter. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define a blending system. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. The claims as follows are intended to include all modifications and alterations insofar as they come within the scope of the claims or the equivalent thereof.

What is claimed is:

1. A blender apparatus comprising:
a container;
a blade assembly operatively positioned in the container; and
a puck assembly comprising a retainer nut, wherein the retainer nut is not directly attached to the container.

2. The blender apparatus of claim 1, wherein the blade assembly is positioned into and through the puck assembly.

3. The blender apparatus of claim 1, wherein the blade assembly includes a bearing housing, the bearing housing free of contact with the container.

4. The blender apparatus of claim 3, wherein the bearing housing contacts the retainer nut.

5. The blender apparatus of claim 4, wherein the retainer nut includes an elastomeric material dampening the blade assembly.

6. The blender apparatus of claim 1, wherein the container comprises a cavity with a first engaging member and the retainer nut comprises a second engaging member whereby the first and second engaging members nestingly engage each other.

7. The blender apparatus of claim 6, wherein nesting engaging of the first and second engaging members operatively align the retainer nut with the container.

8. The blender apparatus of claim 6, wherein the first engaging member comprises a protrusion and the second engaging member comprises a groove.

9. A blender apparatus comprising:
a blender base comprising a motor;
a container operatively engageable with the blender base; and
a blade assembly isolated from the container, the blade assembly in operatively coupled with the motor.

10. The blender apparatus of claim 9 further comprising a puck assembly, wherein the blade assembly is inserted through the puck assembly and the puck assembly is not directly attached to the container.

11. The blender apparatus of claim 10, wherein the puck assembly comprises a retainer nut, wherein the retainer nut is not directly attached to the container.

12. The blender apparatus of claim 11, wherein the retainer nut comprises an elastomeric material.

13. The blender apparatus of claim 11, wherein the retainer nut does not screw, bolt or fasten directly to the blade assembly or container.

14. The blender apparatus of claim 13 further comprising a retainer plate compressing the retainer nut and operatively positioning the retainer nut relative to the container.

15. The blender apparatus of claim 14, wherein the retainer plate is attached to the container.

16. A puck assembly for a blender apparatus comprising:
a body operatively coupled to a blade assembly; and
an identification tag disposed within the puck assembly.

17. The puck assembly of claim 16, wherein the identification tag comprises an NFC chip and antenna.

18. The puck assembly of claim 17, wherein the puck assembly includes a retainer nut comprises a chamber in which the NFC chip and antenna are operatively positioned.

19. The puck assembly of claim 18, wherein the NFC chip and antenna are hermitically sealed.

20. The puck assembly of claim 16, wherein the identification tag is adapted to communicate with a blender base.
